(19) United States
(12) Patent Application Publication
(10) Pub. No.: US 2007/0047237 A1
(43) Pub. Date: Mar. 1, 2007

(54) Method of forming a lamp assembly

(76) Inventors: Jimmy Perez, Corvallis, OR (US); Kenneth Todd Coykendall, Corvallis, OR (US); John W. Lee, Sweet Home, OR (US); Tim M. Bartel, Salem, OR (US); David E. Huhn, Monmouth, OR (US); Andrew R. Lovvorn, Albany, OR (US); Robert C. Sattem, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/215,961

(22) Filed: Aug. 30, 2005

(51) Int. Cl. F21V 15/00

(52) U.S. Cl. 362/362

(57) ABSTRACT

An exemplary method of forming a lamp assembly is provided herein that includes scanning at least one surface of a reflector. The method further includes determining an estimated location of a focal point of the reflector based on the scanning, and aligning a burner relative to the estimated location of said focal point.

### RELATED APPLICATIONS

This application is related to “Method of Forming a Burner Assembly”, by Tim M. Bartel et al., Attorney Docket No. 200500034-1, which is filed concurrently with this application.

### BACKGROUND

Digital projectors, such as digital micro-mirror devices (DMD) and liquid crystal device (LCD) projectors, project high quality images onto a viewing surface. Both DMD and LCD projectors utilize high intensity lamps and reflectors to generate the light needed for projection. Light generated by the lamp is concentrated as a “fireball” that is located at a focal point of a reflector. Light produced by the fireball is directed into a projection assembly that produces images and utilizes the generated light to illuminate the image. The image is then projected onto a viewing surface. Misalignment of the focal point causes degradation of the image since less light is captured and creates “hot spots” on the screen instead of a uniform brightness.

Efforts have been directed at making projectors more compact while making the image of higher and better quality. As a result, the lamps utilized have become more compact and of higher intensity. Higher intensity lamps produce high, even extreme heat. The outer surface of the lamps can approach temperatures of 900 degrees C. As a result, projector designs must account for the intense heat. In addition, losses due to misalignment of the fireball with respect to the reflector are amplified in systems utilizing high intensity lamps.

Some methods of aligning the fireball with respect to the reflector include lighting the burner until the burner reaches its operating temperature. Thereafter, the burner is moved relative to the reflector to place the burner as near as possible to the focal point of the reflector and thereby maximize the light output of the lamp assembly. The burner is moved relative to the reflector until the light output of the lamp assembly is at an acceptable level. Such an approach may be time consuming.

### SUMMARY

An exemplary method of forming a lamp assembly is provided herein that includes scanning at least one surface of a reflector. The method further includes determining an estimated location of a focal point of the reflector based on the scanning, and aligning a burner relative to said estimated location of said focal point.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a display system according to one exemplary embodiment.

FIG. 2 illustrates a burner according to one exemplary embodiment.

FIG. 3 is a flowchart illustrating a method of forming a lamp assembly according to one exemplary embodiment.

FIG. 4 is a flowchart illustrating a method of locating a fireball according to one exemplary embodiment.

FIG. 5 is a flowchart illustrating a method of estimating the location of a focal point of a reflector according to one exemplary embodiment.

Throughout the drawings, identical reference numbers designate similar, but not necessarily identical, elements.

### DETAILED DESCRIPTION

A method and system is provided herein for forming a lamp assembly for use in a display system. The lamp assembly according to one exemplary embodiment includes a burner and a reflector. The burner generates light, which is then directed by the reflector to a light modulator assembly. The percentage of light generated by the burner that is directed to the light modulator assembly is dependent, at least in part, on the alignment and orientation of the burner relative to the reflector. According to one exemplary embodiment, the burner and reflector may be aligned while minimizing the operation of the lamp assembly.

According to one exemplary embodiment, the features of the burner may be identified. These features may then be analyzed to determine the proper position and orientation of the burner relative to a known point or surface. The location of the focal point of the reflector may also be established, such as by performing a surface scan of the reflector, and analyzing the surface scan to estimate the focal point of the reflector. Thereafter, the burner and reflector may be oriented, aligned, and secured in an aligned position. An exemplary display system will first be discussed, followed by a discussion of an exemplary lamp assembly and a method of forming a lamp assembly.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

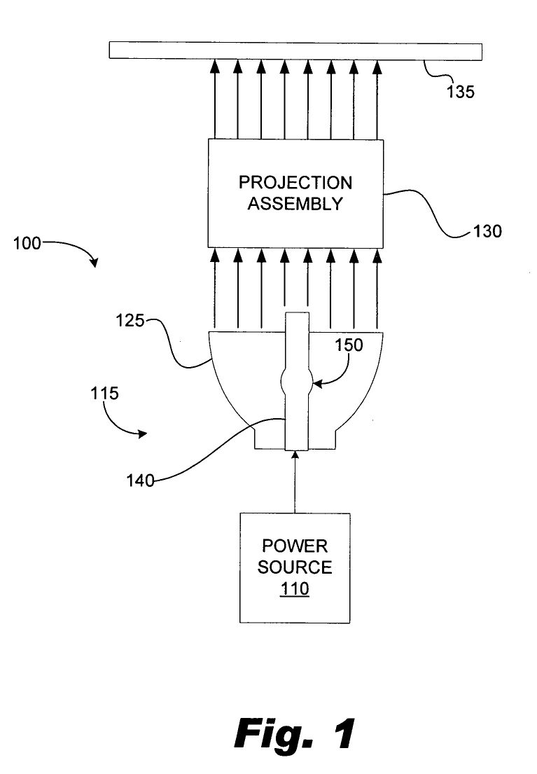

FIG. 1 is a schematic view of a display system (100). The display system (100) generally includes a power source (110), a lamp assembly (115) including a burner (140) and a reflector (125), a light modulator or projection assembly (130), and a viewing surface (135). According to the present exemplary embodiment, the burner (140) is oriented relative to the reflector (125). The power source (110) is also coupled to the burner (140).

The burner (140) may be precisely aligned relative to the reflector (145). For example, when operating the burner (140) produces a fireball located near a central portion (150) of the burner. The location of the fireball may be established using various processes, which may include using a visual alignment process while the burner (140) is not in operation.

The location of focal point of the reflector (125) may also be determined while the burner (140) is not in operation, as will be discussed in more detail below. With the location of the fireball and the location of the focal point of the reflector thus determined, the fireball may then be aligned relative to the focal point of the reflector (125). With the fireball thus aligned relative to the focal point of the reflector (125), the light output of the lamp assembly (117) may thus be maximized. An exemplary method of forming a lamp assembly, including an exemplary method of determining the focal point of the reflector will now be discussed in more detail.

Burner

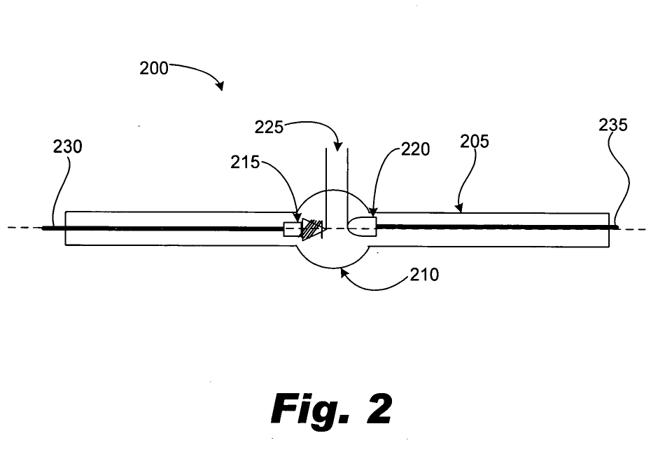

FIG. 2 illustrate a perspective view of a burner (200). The burner (200) includes a glass tube (205) with a central portion (210). A first electrode (215) and a second electrode (220) are sealed within the tube (205) and are separated by a gap (225) near the central portion (210) of the glass tube (205).

A voltage differential may be created at the opposing electrodes in the burner (200). In particular, a first lead wire (230) is coupled to the first electrode (215) and a second lead wire (235) is coupled to the second electrode (220). The first and the second lead wires (230, 235) may then be coupled to a power source that established a voltage difference therebetween. This voltage differential creates a fireball in the central portion (210) of the burner (200) as the voltage arcs between the first and second electrodes (215, 220). In the case of an ultra-high pressure (UHP) burner, the central portion of the glass tube (205) is filled with mercury vapor or other vapor that results in the generation of a plasma caused by an arc across the first and second electrodes (215, 220). The plasma generates a fireball of intense light at some location in the central portion (210) of the burner (200).

The location of the arc between the first and second electrodes (215, 220) may vary as the burner (200) is heated and reaches a steady operating temperature. Thus, the location of the arc, or the fireball, may cause the location of the fireball to vary from the center of the central portion (210) of the burner (200).

The location of the fireball relative to a reference point may be ascertained by any suitable method. Such a reference point may include a burner fixture or a lamp header. For example, the location of the fireball relative to a reference point may be established. Further, the location of the features relative to the same reference point may also be determined. Thereafter, location of features of other burners may be used to estimate the location of the fireball relative to a known reference point. Such a process will be discussed in more detail below.

Thus, the location of features of an individual burner relative to a reference point may be used to estimate the location of the fireball. The location of the focal point of a reflector may also be estimated while minimizing the firing of the burner. With the location of the fireball and the location of the focal point of the reflector known, the burner (200) may be aligned relative to the reflector. An exemplary method of forming a lamp assembly will now be discussed in more detail.

Method of Forming a Lamp Assembly

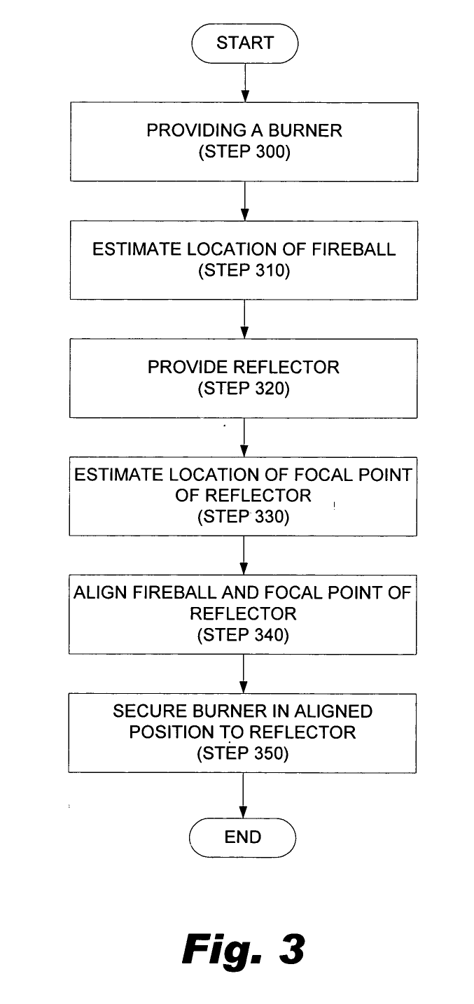

FIG. 3 is a flowchart illustrating a method of forming a lamp assembly according to one exemplary embodiment. The method includes by providing a burner (step 300), determining the location of a fireball relative to a reference point (step 310), providing a reflector (320), estimating a location of the focal point of the reflector (step 330) relative to a second reference point, using the first and second reference points to align the focal point of the reflector to the fireball in an aligned position (step 340), and securing the reflector and burner in the aligned position (step 350). Each of these steps will be discussed in more detail below.

As introduced, the present exemplary method begins by providing a burner (step 300). According to one exemplary embodiment, providing a burner includes providing an ultra-high pressure (UHP) mercury type burner. For ease of reference, an ultra-high pressure mercury type burner will be discussed, while those of skill in the art will appreciate that other types of burners may be used.

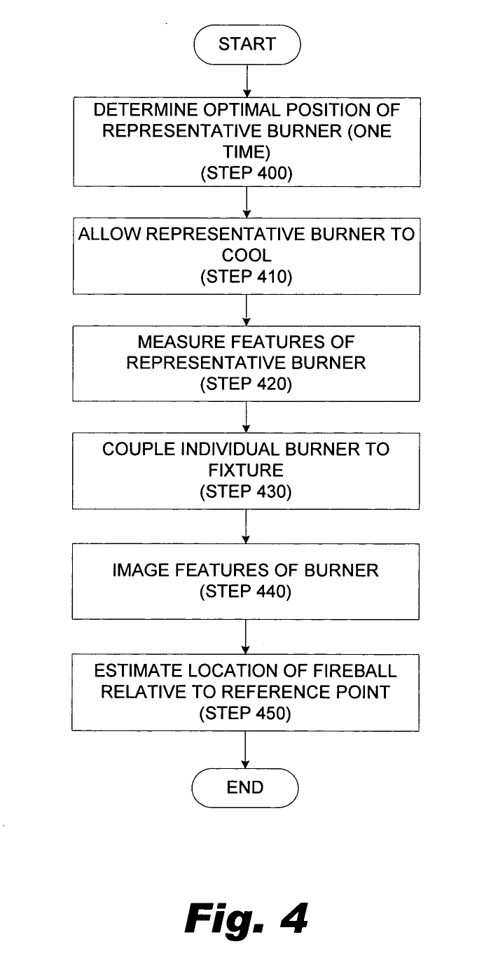

Further, as introduced, the location of the fireball of the burner relative to a reference point is also estimated (step 310). FIG. 4 is a flowchart illustrating an exemplary method of locating a fireball. In particular, FIG. 4 illustrates a method of aligning a burner relative to a reference point. The fireball location and alignment method begins by determining the optimal position of a representative burner relative to a reference point (step 400). The determination of the optimal position of the burner relative to a representative reflector may be performed a single time. Thereafter, the subsequent steps of the process may be performed while the burner is cold.

According to one exemplary method, the optimal position of representative burner relative to a reflector may be directly measured. According to such a process, a representative burner is coupled to a representative reflector. The relative position of the burner is then varied with respect to the reflector until a maximum light output is obtained, thereby providing a location and orientation of the burner relative to the reflector that corresponds with a location of the fireball at or near the focal point of the reflector.

Thereafter, the burner may be inactivated and allow to cool (step 410). The burner may then be removed from the reflector and the location of the features of the burner relative to the reference point may be measured. These locations may then be recorded for later use. While one set of features has been discussed above, any number of burners may be obtained with any number of visual features that may be measured and analyzed. Accordingly, the output of a representative lamp may be optimized and the corresponding position features relative to a header may be determined.

Further, according to another exemplary method, several burners may be constructed in which the orientation and alignment of each of the burners relative to a corresponding header is known and is varied from burner to burner by a controlled amount. Thereafter, each burner may be coupled to a reflector and fired. The output of each burner may then be recorded and analyzed to determine which burner has suitable light output characteristics.

The features of these burners may then be measured to determine the relative location of burner features to the reference point (step 420). More specifically, while the burner is hot and aligned relative to the reflector, the fireball is located at the focal point of the reflector. Thus, the location of the fireball relative to the reference point is known. As the burner cools, the location of these features relative to the reference point may also be established. Thus, knowledge of the location of features relative to a reference surface may be used to extrapolate the location of the fireball of a burner relative to the known point without firing the burner, as will now be discussed in more detail. These preliminary steps, steps, 400, 410, and 420 may be performed a single time on a representative burner assembly. Thereafter, the location of individual burners may each be estimated, as will now be discussed in more detail.

Thus, once the optimal position of a representative burner has been determined relative to a reference point, the subsequent processes may be performed while each burner is cold. According to the present exemplary embodiment, an individual burner may be coupled to a burner fixture (step 430). Coupling the burner to the burner fixture includes establishing the location of a known point or surface. Such a known point or surface may correspond to a reference point or surface on the burner fixture. Further, the burner may be placed in the fixture such that a longitudinal axis of the burner is visible from two or more orthogonal views.

The features of the burner are then imaged (step 440). In particular, the features of the burner may be acquired by a vision system. For example, a vision system may be arranged relative to the burner such that the lamp is able to view the burner from two orthogonal perspectives, both of which profile the longitudinal axis of the burner. By capturing a plurality of orthogonal views, the system is able to accurately determine the location and orientation of the burner in three-dimensions. In particular, by capturing a first orthogonal view, the orientation and position of features in the burner may be known in a first plane. Thereafter, by capturing a second orthogonal view, the orientation and position of the features may be further known in a second plane. When the orientation and position of the features are known in two orthogonal planes, such as by capturing two orthogonal views that are normal to each other, the positions of the features are known in three dimensions.

According to one exemplary method, the edges of a glass tube may be first located in the image. If the edges are found, the area of the image outside of the edges may be eliminated from further consideration. Eliminating the rest of the image from consideration may reduce subsequent imaging and/or computational requirements by reducing the area to be analyzed. As a result, eliminating the image beyond the edges of the glass tube may speed up subsequent steps of the process. The process may be performed regardless of whether the edges of the glass tube are found.

Accordingly, once the edges of the tube have been found or it has been determined that they will not be found, any other possible features of the correct size, shape, and/or intensity are located in the image. Such features may include, but are not limited to, the electrodes, coils, filament, and shape of the central portion of the glass tube. Logic is then applied to the measurements to eliminate spurious noise features. For example, a measured distortion to the shape of an electrode may be more likely mercury or other material within the glass tube than non-uniformity of the electrode itself and may be filtered out.

The location of a representative fireball and features relative to the known reference point may be established. Accordingly, the location of the fireball may be estimated relative to the reference point (step 450). In particular, if the location of the reference point on the burner to be used is known relative to the features of that burner, the location of the fireball may be estimated using the locational relationships between the reference point and the fireball and features of the representative burner.

As introduced, once the output of a representative burner and reflector have been established, the location of a fireball relative to a reference point may be performed for similar burners without directly measuring the position of the burner relative to the reflector while the burner is heated to an operating temperature. Thus, the burner may be aligned relative to a reference point or surface using an optical system while the burner is cool.

Returning again to FIG. 3, the present exemplary method also includes providing a reflector (step 320). According to one exemplary embodiment, providing a reflector includes providing a glass reflector with a reflective surface formed on a reflective surface. For ease of reference, a glass reflector will be discussed, while those of skill in the art will appreciate that other types of reflectors, such as metallic reflectors, may also be provided.

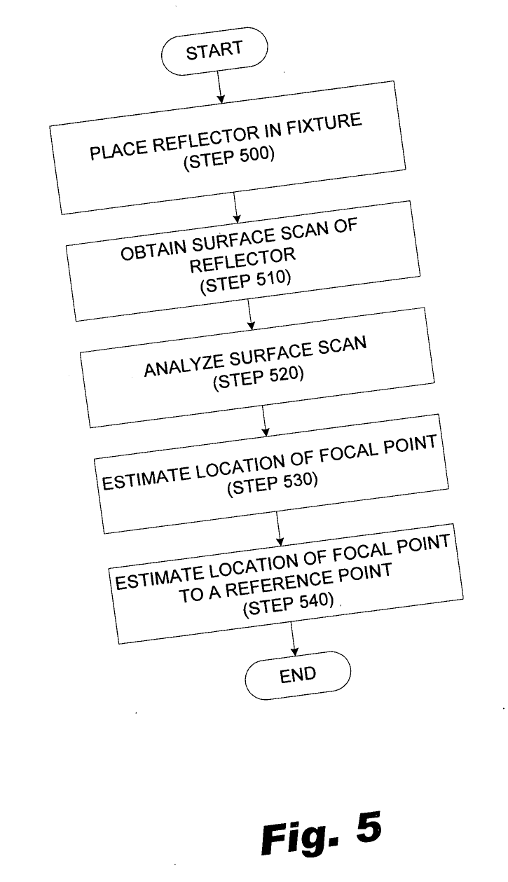

The focal point of the reflector is then located (step 330). FIG. 5 is a flowchart illustrating a method of locating the focal point of a reflector according to one exemplary embodiment. FIG. 5 illustrates a method of locating a focal point of a reflector according to one exemplary embodiment. The method begins by placing the reflector in a fixture (step 500). Further, placing the reflector in a fixture may include establishing a second reference point or surface. For example, locating the reflector in a fixture may provide a baseline or known original location and orientation of the reflector.

Thereafter, a surface scan of the reflective surface of the reflector is obtained (step 510). For example, according to one exemplary method, the surface profile of the reflective surface may be obtained by scanning the reflective surface and analyzing the results of the scan. Any suitable surface scanning process may be used. Suitable surface scanning processes include, without limitation, optical scanning and contact scanning.

The surface scan of the reflective surface is then analyzed (step 520). For example, according a curve-fit process is performed on the surface scan to generate a three-dimensional hyperbolic surface profile. The three-dimensional surface profile is then used to estimate the focal point of the reflector (step 530). The location of the focal point relative to a reference point, such as a point on the reflector, may then be established (step 540).

Referring again to FIG. 3, with knowledge of the location of the fireball in the burner and the focal point of the reflector, the burner may be coupled to the reflector (step 340). In particular, the reference point or surface on the burner may be placed at a location and orientation relative to reflector such that the fireball is at or near the focal point of the reflector. More specifically, as previously discussed, the location of the fireball may be established, as well as the location and orientation of the reference point relative to the focal point of the reflector. Thus, using this information, the fireball may be placed at or near the focal point of the reflector.

With the burner thus located and oriented relative to the reflector, the aligned relationship may be secured (step 350). In particular, according to one exemplary the burner may be secured directly to the reflector using high-temperature adhesive. For example, a UHP burner may be secured to a glass reflector by applying high temperature adhesive to the burner and reflector.

Thus, the present method provides for the formation of a lamp assembly by determining the focal point of the reflector and placing the fireball of the burner at the reflector. The location of the fireball and the location of the burner may each be determined without firing the burner. Such a process may allow for relatively rapid formation time while minimizing the possibility that workers may come into contact with a hot burner. An exemplary method of locating the focal point of a reflector will now be discussed in more detail.

In conclusion, a method and system have been described herein for forming a lamp assembly for use in a display system. The lamp assembly according to one exemplary embodiment includes a burner and a reflector. The burner generates light, which is then directed by the reflector to a light modulator assembly. The percentage of light generated by the burner that is directed to the light modulator assembly is dependent, at least in part, on the alignment and orientation of the burner relative to the reflector. According to one exemplary embodiment, the burner and reflector may be aligned while minimizing the operation of the lamp assembly.

According to one exemplary embodiment, the features of the burner may be identified. These features may then be analyzed to determine the proper position and orientation of the burner relative to a known point. The location of the focal point of the reflector may also be established, such as by performing a surface scan of the reflector, and analyzing the surface scan to estimate the focal point of the reflector. Thereafter, the burner and reflector may be oriented, aligned, and secured in an aligned position.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A method of forming a lamp assembly, comprising:
scanning at least one surface of a reflector;
determining an estimated location of a focal point of said reflector based on said scanning; and
aligning a burner relative to said estimated location of said focal point.

2. The method of claim 1, wherein scanning said at least one surface includes performing a surface scan of a reflective surface of said reflector.

3. The method of claim 2, wherein performing said surface scan includes performing an optical surface scan of said reflective surface.

4. The method of claim 1, wherein scanning said at least one surface includes generating a surface profile of a reflective surface of said reflector, and said determining an estimated location of said focal point includes curve fitting said surface profile.

5. The method of claim 1, wherein aligning said burner includes a preliminary step of estimating a location of a fireball of said burner, and aligning said fireball relative to said estimated location of said focal point.

6. The method of claim 5, wherein estimating a location of said fireball includes analyzing features of said burner while said burner is in a non-operating condition.

7. The method of claim 1, wherein determining said estimated location of focal point of said reflector is performed while said burner is in a non-operating condition.

8. The method of claim 1, and further comprising securing said burner to said reflector.

9. The method of claim 8, wherein securing said burner to said reflector includes applying a high-temperature adhesive.

10. A method of forming a lamp assembly, comprising:
providing a burner and a reflector;
estimating a location of a fireball of said burner while said burner is an a non-operating state;
estimating a location of a focal point of said reflector while said burner is in said non-operating state; and
aligning said fireball to said focal point.

11. The method of claim 10, wherein providing said reflector includes providing a glass reflector.

12. The method of claim 10, wherein said estimating said location of said focal point includes scanning at least one surface of said reflector and determining an estimated location of said focal point of said reflector based on said scanning.

13. The method of claim 10, wherein estimating a location of said fireball includes capturing at least one feature of a burner with an imaging system and determining said location of a fireball based on a location of said at least one feature relative to a reference point.

14. The method of claim 13, wherein determining said location of said fireball based on said location of said at least one feature relative to said reference point includes determining said location of said fireball relative to a fixture.

15. The method of claim 10, and further comprising securing burner to said reflector.

16. The method of claim 15, wherein securing said burner to said reflector includes applying a high-temperature adhesive.

17. The method of claim 10, wherein providing said burner includes providing an ultra-high pressure mercury burner.

18. A system for forming a lamp assembly, comprising:
means for determining an estimated location of a fireball of a burner while said burner is in a non-operating state;
means for determining an estimated location of a focal point of a reflector while said burner is in a non-operating state; and
means for aligning said fireball to said focal point.

19. The system of claim 18, wherein said means for determining an estimated location of said focal point includes means for obtaining a surface profile of a reflective surface of said reflector.

20. The system of claim 18, wherein said means for determining an estimated location of said fireball includes means for capturing at least one feature of said burner.
